(19) United States
(12) Patent Application Publication
(10) Pub. No.: US 2022/0053031 A1
(43) Pub. Date: Feb. 17, 2022

(54) METHODS AND DEVICES FOR CONTINUATION OF TERMINATING SERVICES IN IMS COMMUNICATION NETWORKS

(71) Applicant: Telefonaktiebolaget LM Ericsson (publ), Stockholm (SE)

(72) Inventors: Sicong Huang, Shanghai (CN); BeiLin Xu, Shanghai (CN); Liangliang Guo, Shanghai (CN)

(21) Appl. No.: 17/420,299

(22) PCT Filed: Dec. 11, 2019
(86) PCT No.: PCT/CN2019/124548

§ 371 Date: Jul. 1, 2021

(30) Foreign Application Priority Data
Jan. 18, 2019 (CN) PCT/CN2019/072369

(51) Int. Cl. H04L 29/06

(52) U.S. Cl. CPC H04L 65/1016; H04L 65/1046; H04W 60/00; H04L 65/1073; H04L 65/105

(57) ABSTRACT

A method implemented by a first network node in an IMS communication network is provided. The method may comprise: receiving a register request from a user equipment; and transmitting the register request which comprises contact information of the user equipment to a second network node. In the present disclosure, the P-CSCF may be able to route the terminating requests without UE registration bindings, which increases a successful rate of the terminating services.

### TECHNICAL FIELD

The present disclosure generally relates to Internet protocol Multimedia Subsystem (IMS) communication networks, and more specifically to methods and devices for continuation of terminating services in IMS communication networks.

### BACKGROUND

This section introduces aspects that may facilitate better understanding of the present disclosure. Accordingly, the statements of this section are to be read in this light and are not to be understood as admissions about what is in the prior art or what is not in the prior art.

The Third Generation Partnership Project (3GPP) has defined P-CSCF (Proxy—Call Session Control Function) restoration procedures to recover services for a user equipment (UE) when a terminating request cannot be routed because of P-CSCF failures.

When an S-CSCF (Serving—Call Session Control Function) detects a P-CSCF failure, it may either report the failure to an HSS (Home Subscriber Server) or inform an EPC (Evolved Packet Core) or a 5GC (5^{th} Generation Core) or equivalent core networks via an Rx interface of a PCRF (Policy and Charging Rules Function). In the first scenario, the HSS further informs the EPC that the P-CSCF restoration is required for the UE. The EPC requests the UE to perform an initial registration in which the UE may register with an available P-CSCF. The terminating services may then be resumed. In the second scenario, the PCRF informs the EPC to request the UE to perform an initial registration with an available P-CSCF.

In the P-CSCF restoration, however, the first terminating request may go through the failed P-CSCF. Only when no response to the terminating request is received, does the S-CSCF detect the failure of the P-CSCF. The first terminating request will not be responded to. Moreover, the P-CSCF restoration relies upon use of the EPC and only works for VoLTE (Voice over Long-Term Evolution) equipment. There is no existing solution to recover the services for other accesses than VoLTE that are connected to the failed P-CSCF. Furthermore, one P-CSCF usually serves a large amount of UEs, all of which should be informed during the P-CSCF restoration. This significantly loads extra signaling over the EPC.

### SUMMARY

It is an object of the present disclosure to provide a mechanism to continue any terminating services towards a UE by retransmitting the terminal services to another P-CSCF when the serving P-CSCF with which the UE registers becomes unavailable.

Data for contacting the UE is stored in the HSS/S-CSCF during registration for the terminating services. The UE is served by more than two P-CSCFs. The UE may obtain a list of the serving P-CSCFs from a P-CSCF discovery procedure. The S-CSCF may obtain information on which P-CSCFs serve the UE by either pre-configuration of the P-CSCFs or receipt of a session initiation protocol (SIP) content during the UE registration. In case of a P-CSCF failure, the S-CSCF may use backup P-CSCF information to route the terminating requests to a backup P-CSCF on which no user binding is found. The backup P-CSCF may use the information from the terminating requests to route the requests to the UE.

According to a first aspect of the present disclosure, a method implemented by a user equipment in an IMS communication network is provided. The method may comprise: transmitting, to a first network node, a register request comprising a list of network nodes for the user equipment; and receiving a terminating request from the first network node or a third network node included in the list.

In an alternative embodiment of the first aspect, the register request may further comprise routing information of the user equipment in a contact header or a path header of the register request.

In another alternative embodiment of the first aspect, the first network node and other network nodes included in the list may be Proxy Call Session Control Function nodes.

According to a second aspect of the present disclosure, a method implemented by a first network node in an IMS communication network is provided. The method may comprise: receiving a register request from a user equipment; and transmitting the register request which comprises contact information of the user equipment to a second network node.

According to a third aspect of the present disclosure, a method implemented by a second network node in an IMS communication network is provided. The method may comprise: receiving a register request comprising contact information of a user equipment from a first network node; transmitting a terminating request to a network node included in a list of network nodes for the user equipment.

According to a fourth aspect of the present disclosure, a method implemented by a third network node in an IMS communication network is provided. The method may comprise: receiving a terminating request comprising contact information of a user equipment from a second network node; and transmitting the terminating request to the user equipment.

According to a fifth aspect of the present disclosure, a user equipment in an IMS communication network is provided. The user equipment may comprise a processor and a memory communicatively coupled to the processor. The memory may be adapted to store instructions which, when executed by the processor, may cause the user equipment to perform operations of the method according to the above first aspect.

According to a sixth aspect of the present disclosure, a first network node in an IMS communication network is provided. The first network node may comprise a processor and a memory communicatively coupled to the processor. The memory may be adapted to store instructions which, when executed by the processor, may cause the first network node to perform operations of the method according to the above second aspect.

According to a seventh aspect of the present disclosure, a second network node in an IMS communication network is provided. The second network node may comprise a processor and a memory communicatively coupled to the processor. The memory may be adapted to store instructions which, when executed by the processor, may cause the second network node to perform operations of the method according to the above third aspect.

According to an eighth aspect of the present disclosure, a third network node in an IMS communication network is provided. The third network node may comprise a processor and a memory communicatively coupled to the processor. The memory may be adapted to store instructions which, when executed by the processor, may cause the third network node to perform operations of the method according to the above fourth aspect.

According to a ninth aspect of the present disclosure, an IMS communication system is provided. The IMS communication system may comprise: a user equipment according to the above fifth aspect; a first network node according to the above sixth aspect communicating with at least the user equipment; a second network node according to the above seventh aspect communicating with at least the first network node; and a third network node according the above eighth aspect communicating with at least the user equipment and the second network node.

According to a tenth aspect of the present disclosure, a non-transitory computer readable medium having a computer program stored thereon is provided. When the computer program is executed by a set of one or more processors of a user equipment, the computer program may cause the user equipment to perform operations of the method according to the above first aspect.

According to an eleventh aspect of the present disclosure, a non-transitory computer readable medium having a computer program stored thereon is provided. When the computer program is executed by a set of one or more processors of a first network node, the computer program may cause the first network node to perform operations of the method according to the above second aspect.

According to a twelfth aspect of the present disclosure, a non-transitory computer readable medium having a computer program stored thereon is provided. When the computer program is executed by a set of one or more processors of a second network node, the computer program may cause the second network node to perform operations of the method according to the above third aspect.

According to a thirteenth aspect of the present disclosure, a non-transitory computer readable medium having a computer program stored thereon is provided. When the computer program is executed by a set of one or more processors of a third network node, the computer program may cause the third network node to perform operations of the method according to the above fourth aspect.

In the present disclosure, the P-CSCF may be able to route the terminating requests without UE registration bindings, which increases a successful rate of the terminating services. Moreover, since the solution of the present disclosure does not need to invoke out-of-band nodes like the HSS, the EPC nodes, etc. as in the 3GPP P-CSCF restoration procedures, such extra signaling can be saved. Furthermore, since all data for contacting the UE is stored during the registration and purely based on SIP, no extra interfaces or signaling are needed. Generally, the solution may be applied to any SIP networks.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a schematic diagram illustrating a continuation process of terminating services according to some embodiments of the present disclosure;

FIG. 2 is an exemplary sequence diagram illustrating a process of UE registration according to some embodiments of the present disclosure;

FIG. 3 is an exemplary sequence diagram illustrating a process of transmission of terminating requests according to some embodiments of the present disclosure;

FIG. 4 is a flow chart illustrating a method implemented on a UE according to some embodiments of the present disclosure;

FIG. 5 is a flow chart illustrating a method implemented on a first network node according to some embodiments of the present disclosure;

FIG. 6 is a flow chart illustrating a method implemented on a second network node according to some embodiments of the present disclosure;

FIG. 7 is a flow chart illustrating a method implemented on a third network node according to some embodiments of the present disclosure;

FIG. 8 is a block diagram illustrating a UE according to some embodiments of the present disclosure;

FIG. 9 is another block diagram illustrating a UE according to some embodiments of the present disclosure;

FIG. 10 is a block diagram illustrating a first network node according to some embodiments of the present disclosure;

FIG. 11 is another block diagram illustrating a first network node according to some embodiments of the present disclosure;

FIG. 12 is a block diagram illustrating a second network node according to some embodiments of the present disclosure;

FIG. 13 is another block diagram illustrating a second network node according to some embodiments of the present disclosure;

FIG. 14 is a block diagram illustrating a third network node according to some embodiments of the present disclosure;

FIG. 15 is another block diagram illustrating a third network node according to some embodiments of the present disclosure; and

FIG. 16 is a block diagram illustrating an IMS communication system according to some embodiments of the present disclosure.

### DETAILED DESCRIPTION

The following detailed description describes methods and devices for continuation of terminating services in IMS communication networks. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure. In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof.

The term “terminal device” refers to any end device/client that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like. In the following description, the terms “terminal device”, “client” and “UE” may be used interchangeably.

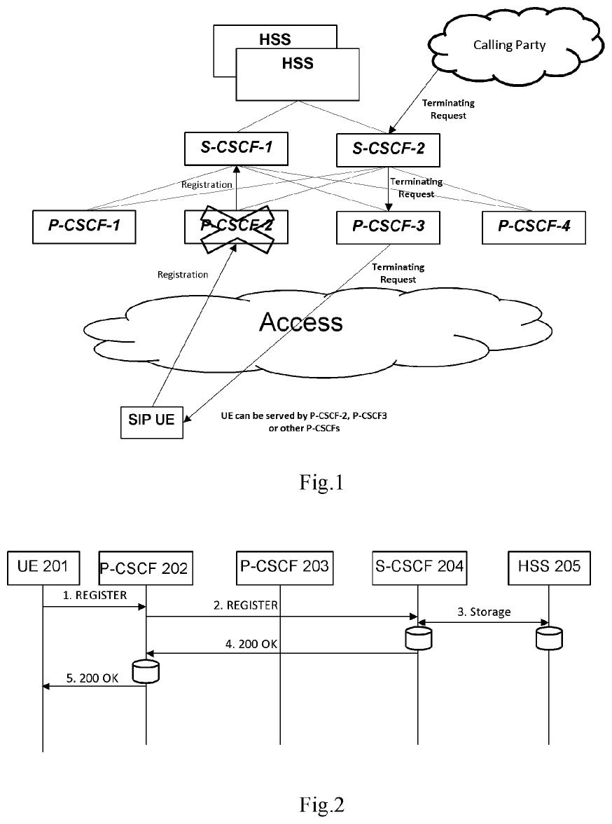

FIG. 1 is a schematic diagram illustrating a continuation process of terminating services in an IMS communication network according to some embodiments of the present disclosure. At first, a UE may be registered with a P-CSCF, e.g., P-CSCF-2 as shown in FIG. 1. In an example, the UE may insert routing information into a Contact header of a REGISTER message. The Contact header may be used as a request URI (Uniform Resource Identifier) for terminating requests later. In another example, the routing information may be inserted by P-CSCF-2 into the Contact header. In a further example, prior to P-CSCF-2, the REGISTER may pass through a proxy (not shown) for the UE, and the routing information may be comprised in a Path header, which indicates passage through the proxy, of the REGISTER.

P-CSCF-2 may forward the REGISTER to an S-CSCF, e.g., S-CSCF-1 as shown in FIG. 1. S-CSCF-1 may store the routing information as opaque data in the HSS. In an example, S-CSCF-1 or S-CSCF-2 may put the routing information into a proper place (e.g., SIP URI) of a request URI of a terminating request to be sent to P-CSCF-2.

A terminating request may be routed to S-CSCF-2 from a calling party, as shown in FIG. 1. S-CSCF-2 may route the terminating request to the previous P-CSCF.

A failure may occur on P-CSCF-2 and cause P-CSCF-2 to be unavailable or to lose registration data (e.g., site reboot). In this case, when S-CSCF-2 detects the failure, it may select a P-CSCF which is capable of serving the UE. The selected P-CSCF, e.g., P-CSCF-3 as shown in FIG. 1, may allow transmission of the terminating request to an unregistered UE. P-CSCF-3 may obtain the information from the request URI and send the SIP request to the UE.

Since the UE may not be served by all of the P-CSCFs connected to the IMS core network, S-CSCF-2 has to know a list of P-CSCFs which are capable of serving the UE to ensure that the selected P-CSCF can route the terminating request to the UE. In an example, during a P-CSCF discovery process, the UE may receive the list of P-CSCFs which can provide services to it. The UE may add such information to e.g. a private header P-PCSCF-Address of the REGISTER, or to any other header or header parameter in the REGISTER. In another example, the S-CSCF may be configured with a pre-configured P-CSCF pool for different subnetworks of users. This configuration should be synchronized with the EPC so that the pool may reflect an actual serving relationship between the UEs and the P-CSCFs.

FIG. 2 is an exemplary sequence diagram illustrating a process of UE registration in an IMS communication network according to some embodiments of the present disclosure. An IMS communication system is shown in FIG. 2, comprising at least a UE 201, a P-CSCF 202, a P-CSCF 203, an S-CSCF 204 and an HSS 205. The process shown in FIG. 2 depicts a registration procedure in which the UE 201 registers with the P-CSCF 202.

At step 1, the UE 201 may transmit a REGISTER to the serving P-CSCF 202. In an example, the REGISTER may comprise a list of P-CSCFs which are capable of serving the UE 201. The list may be comprised in a SIP header of the REGISTER. Routing information for the UE 201 may also be comprised in the Contact header. In the case that the REGISTER passes through a proxy for the UE 201 as described with respect to FIG. 1, the routing information for the UE 201 may be inserted by the proxy into a Path header, which indicates passage through the proxy, of the REGISTER.

A special type of routing information is referred to herein as contact information, which includes at least an IP (Internet Protocol) address, a port number and a transport type (e.g., TCP, UDP, etc.) for the UE. The contact information may also be comprised in the Contact header, Path header or a proprietary SIP header of the REGISTER.

At the P-CSCF 202, a host part of the SIP URI in the Contact header may be checked (or check of the Path header field, if any, may be prioritized) before forwarding the REGISTER to the core network. Specifically, if the Path header field or the host part of the SIP URI in the Contact header contains the IP address of the UE 201, the P-CSCF may not change the header. If the IP address of the UE 201 is not found in the Path header field or the host part of the SIP URI in the Contact header, the P-CSCF 202 may add a URI parameter to the Path header or to the SIP URI of the Contact header indicating at least the IP address, the port number and the transport type for the UE 201, e.g., if the Path header field or the host part of the SIP URI in the Contact header contains a domain name, e.g., a Fully Qualified Domain Name (FQDN), then the P-CSCF 202 may replace the domain name with such a URI parameter indicating the contact information for the UE 201. In an example, the P-CSCF 202 may add the contact information for the UE 201 to a proprietary SIP header or SIP header field of the REGISTER.

Then, the P-CSCF 202 may transmit the REGISTER to the S-CSCF 204 at step 2. The REGISTER may be transmitted to the S-CSCF 204 via an I-CSCF (Interrogation—Call Session Control Function) (not shown). The REGISTER may comprise at least a Path header indicating passage through the P-CSCF 202 and the contact information of the UE 201 at this point.

At step 3, the contact information and the Path header(s) may be stored in the HSS 205. At step 4, after a successful registration, the S-CSCF 204 may transmit a 200 OK message to the P-CSCF 202. At step 5, when the P-CSCF 202 receives the 200 OK message, the P-CSCF 202 may store a registration state including the contact information for the registered UE 201.

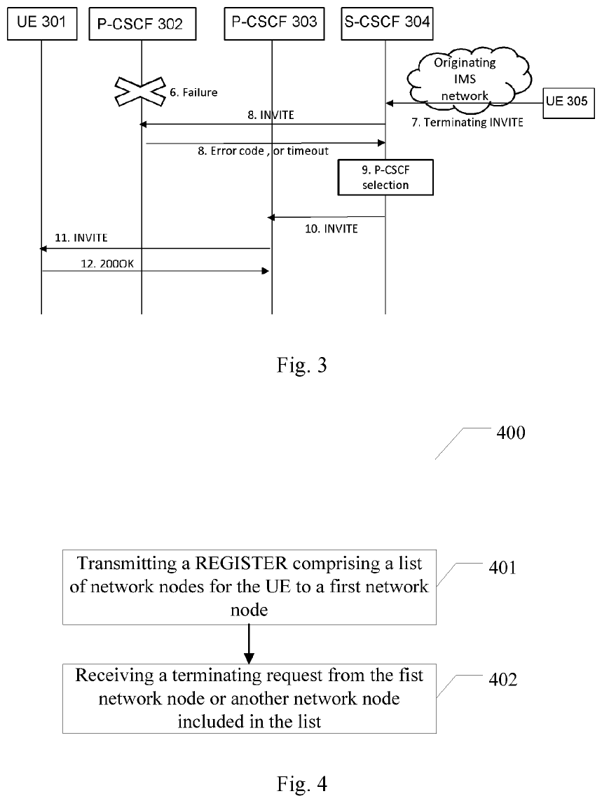

FIG. 3 is an exemplary sequence diagram illustrating a process of transmission of terminating requests in an IMS communication network according to some embodiments of the present disclosure. An IMS communication system is shown in FIG. 3, comprising at least a UE 301, a P-CSCF 302, a P-CSCF 303, an S-CSCF 304 and a UE 305. The process shown in FIG. 3 depicts a follow-up for the procedure shown in FIG. 2 when a failure occurs on the P-CSCF 302.

At step 6, a failure may occur on the P-CSCF 302 which originally served the UE 301.

At step 7, the UE 305, which acts as the calling party, may transmit a terminating request to the S-CSCF 304 through the IMS network. The terminating request is shown in FIG. 3 as an INVITE, but it is not limited thereto and may also be any terminating request like MESSAGE, INFO, NOTIFY, etc.

At step 8, the S-CSCF 304 may not detect the failure of the P-CSCF 302. In this case, the S-CSCF 304 may transmit the INVITE to the failed P-CSCF 302, and some error response codes may be returned or the request may end up with timeout. Particularly, the S-CSCF 304 may check healthiness of the P-CSCF 302 using a heart-beat mechanism, e.g., by transmitting periodical SIP OPTIONs as a health check. If the P-CSCF 302 does not respond to the SIP OPTIONs, the S-CSCF 304 may add the P-CSCF 302 to a blacklist based on a local policy.

At step 9, upon detection of the failure on the P-CSCF 302, the S-CSCF 304 may select a backup P-CSCF, e.g., the P-CSCF 303, from the list of P-CSCFs which can provide services to the UE 301. As described above with respect to FIG. 1, the list may be obtained from a SIP header of the REGISTER transmitted by the UE 301 via the P-CSCF 302, or may be obtained by pre-configuring a P-CSCF pool. The selection may be based on information included in the list.

In an example, the S-CSCF 304 may convert the Path header(s) comprised in the REGISTER into a Route header(s) of the terminating request. In the case that the failure occurs on the P-CSCF 302, the Path header indicating the passage through the failed P-CSCF 302 may be converted into a Route header of the terminating request indicating routing to the backup P-CSCF 303. The S-CSCF 304 may place at least the contact information for the UE 301 and information on the selected P-CSCF into the terminating request.

At step 10, the S-CSCF 304 may transmit the terminating request (e.g. INVITE) to the backup P-CSCF 303. The P-CSCF 303 does not have user registration of the UE 301, but may forward the terminating request to the UE 301 without registration by using at least the contact information.

At step 11, the P-CSCF 303 may prioritize detection of a Route header indicating routing to a proxy for the UE 301 in the INVITE. If this Route header is detected in the INVITE, the P-CSCF 303 may transmit the INVITE to the proxy based on the Route header. If not, the P-CSCF 303 may transmit the INVITE to the UE 301 based on the contact information comprised in the Contact header of the INVITE.

At step 12, when the INVITE is routed to the UE 301 successfully, the UE 301 may transmit a 200 OK back to the P-CSCF 303.

FIG. 4 is a flow chart illustrating a method 400 implemented on a UE in an IMS communication network according to some embodiments of the present disclosure. As an example, operations of this flow chart may be performed by a combination of the UE 201 as shown in FIG. 2 and the UE 301 as shown in FIG. 3, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the method 400 begins with the UE transmitting a REGISTER comprising a list of network nodes (e.g., P-CSCFs) which can serve the UE to a first network node (block 401). The first network node may act as the P-CSCF 202 as shown in FIG. 2 by way of example.

The UE may receive a terminating request from the first network node (e.g., the P-CSCF 302 as shown in FIG. 3) or another network node included in the list (block 402). If a failure occurs on the first network node, the terminating request may be received from the other network node included in the list, e.g., the P-CSCF 303 as shown in FIG. 3.

As an example, the REGISTER may further comprise routing information of the UE in a Contact header. As another example, in the case that the REGISTER passes through a proxy for the UE, the REGISTER may comprise the routing information of the UE in a Path header indicating passage through the proxy.

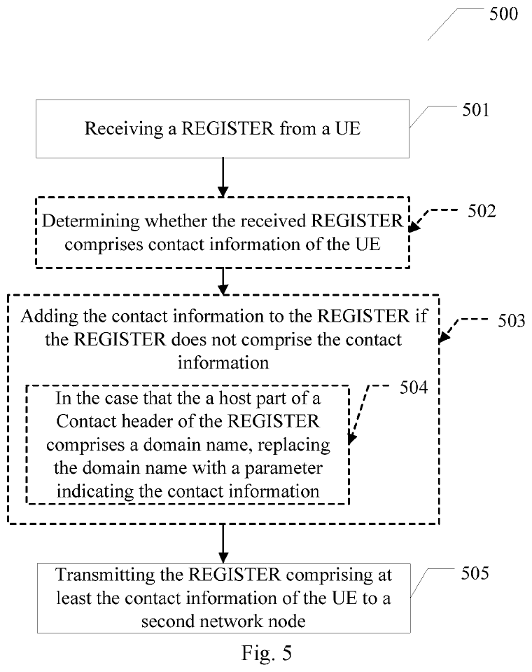

FIG. 5 is a flow chart illustrating a method 500 implemented on a first network node in an IMS communication network according to some embodiments of the present disclosure. As an example, operations of this flow chart may be performed by a combination of the P-CSCF 202 as shown in FIG. 2 and the P-CSCF 302 as shown in FIG. 3.

In one embodiment, the first network node may receive a REGISTER from a UE (block 501). As an example, the UE may be the UE 201 as shown in FIG. 2. Then, the first network node may transmit, to a second network node, the REGISTER which now comprises at least contact information of the UE (block 505) to ensure that the contact information of the UE is transmitted to the second network node. As an example, the second network node may be the S-CSCF 204 as shown in FIG. 2.

The contact information may include at least an IP address, a port number and a transport type for the UE by way of example. As a further example, the REGISTER may further comprise a list of network nodes (e.g., P-CSCFs) which can serve the UE.

As an optional example, upon receipt of the REGISTER from the UE, the first network node may determine whether the received REGISTER comprises the contact information of the UE (block 502), and if not, add the contact information to the REGISTER (block 503). In a specific example, if a host part of a Contact header of the REGISTER comprises a domain name of the UE, then the contact information may be added to the REGISTER by replacing the domain name with a parameter indicating the contact information of the UE (block 504).

As an additional optional example, the first network node may receive periodical heart-beat requests from the second network node (e.g., the S-CSCF 304), and then respond to the periodical heart-beat requests to show that there is no failure on the first network node.

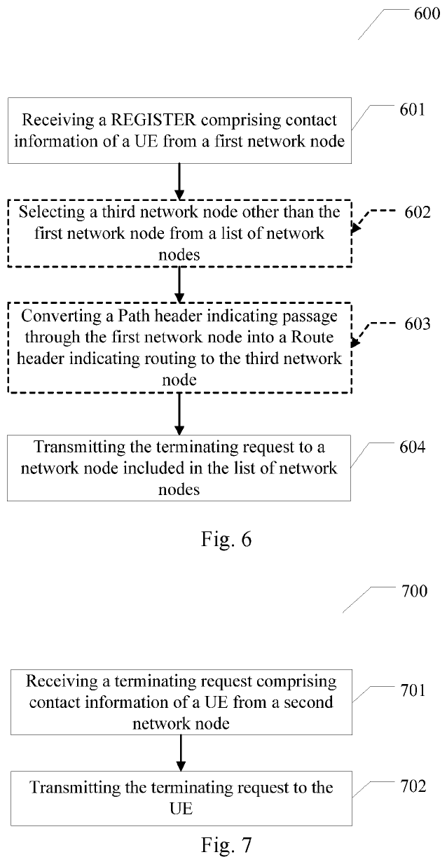

FIG. 6 is a flow chart illustrating a method 600 implemented on a second network node in an IMS communication network according to some embodiments of the present disclosure. As an example, operations of this flow chart may be performed by a combination of the S-CSCF 204 as shown in FIG. 2 and the S-CSCF 304 as shown in FIG. 3.

In one embodiment, the second network node may receive a REGISTER which comprises contact information of a UE from a first network node (block 601). As an example, the UE may be the UE 201 as shown in FIG. 2 and the first network node may be the P-CSCF 202 as shown in FIG. 2. Then, the second network node may transmit a terminating request to a network node included in a list of network nodes (e.g., P-CSCFs) which can serve the UE (block 604).

The contact information may include at least an IP address, a port number and a transport type for the UE by way of example. As an example, the list may be inserted by the UE into the REGISTER. As another example, the list may be obtained by pre-configuring a pool of network nodes (e.g., P-CSCFs) by the second network node.

As an optional example, if no failure is detected on the first network node, then the network node to which the second network node transmits the terminating request may still be the first network node (e.g., the P-CSCF 302 as shown in FIG. 3). As another optional example, upon detection of a failure on the first network node, the second network node may select a third network node (e.g., the P-CSCF 303 as shown in FIG. 3) different from the first network node from the list of network nodes based on information included in the list (block 602). As a further example, the second network node may convert a Path header indicating passage through the first network node and comprised in the REGISTER into a Route header indicating routing to the third network node and comprised in the terminating request (block 603). As an optional example, the contact information may be transmitted in the terminating request to the third network node.

As an example, the second network node may detect the failure on the first network node by transmitting periodical heart-beat requests to the first network node (e.g., the P-CSCF 302 as shown in FIG. 3).

FIG. 7 is a flow chart illustrating a method 700 implemented on a third network node in an IMS communication network according to some embodiments of the present disclosure. As an example, operations of this flow chart may be performed by the backup P-CSCF 303 as shown in FIG. 3.

In one embodiment, the third network node may receive a terminating request which comprises contact information of a UE from a second network node (block 701). As an example, the UE may be the UE 301 as shown in FIG. 3 and the second network node may be the S-CSCF 304 as shown in FIG. 3. Then, the third network node may transmit the terminating request to the UE (block 702).

The contact information may include at least an IP address, a port number and a transport type for the UE by way of example.

As an example, the third network node may determine whether a Route header indicating passage through a proxy for the UE is comprised in the terminating request. If so, the third network node may transmit the terminating request to the proxy based on the Route header, and if not, the third network node may transmit the terminating request to the UE based on a Contact header of the terminating request.

As an example, the third network node may be a backup network node selected by the second network node from a list of network nodes (e.g., P-CSCFs) which are capable of serving the UE.

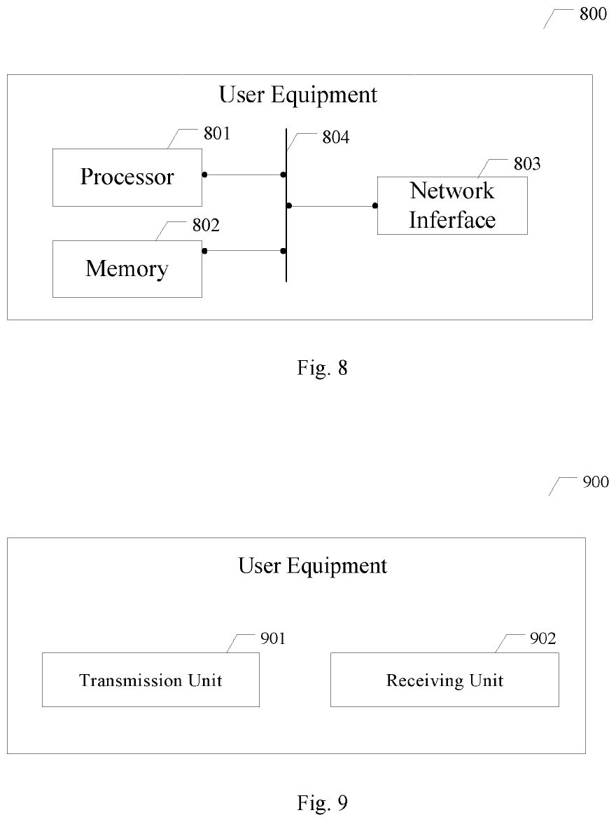

FIG. 8 is a block diagram illustrating a UE 800 in an IMS communication network according to some embodiments of the present disclosure. As an example, the UE 800 may act as a combination of the UE 201 as shown in FIG. 2 and the UE 301 as shown in FIG. 3, but it is not limited thereto. It should be appreciated that the UE 800 may be implemented using components other than those illustrated in FIG. 8.

With reference to FIG. 8, the UE 800 may comprise at least a processor 801, a memory 802, a network interface 803 and a communication medium 804. The processor 801, the memory 802 and the network interface 803 may be communicatively coupled to each other via the communication medium 804.

The processor 801 may include one or more processing units. A processing unit may be a physical device or article of manufacture comprising one or more integrated circuits that read data and instructions from computer readable media, such as the memory 802, and selectively execute the instructions. In various embodiments, the processor 801 may be implemented in various ways. As an example, the processor 801 may be implemented as one or more processing cores. As another example, the processor 801 may comprise one or more separate microprocessors. In yet another example, the processor 801 may comprise an application-specific integrated circuit (ASIC) that provides specific functionality. In still another example, the processor 801 may provide specific functionality by using an ASIC and/or by executing computer-executable instructions.

The memory 802 may include one or more computer-usable or computer-readable storage medium capable of storing data and/or computer-executable instructions. It should be appreciated that the storage medium is preferably a non-transitory storage medium.

The network interface 803 may be a device or article of manufacture that enables the UE 800 to send data to or receive data from some network nodes. In different embodiments, the network interface 803 may be implemented in different ways. As an example, the network interface 803 may be implemented as an Ethernet interface, a token-ring network interface, or another type of network interface.

The communication medium 804 may facilitate communication among the processor 801, the memory 802 and the network interface 803. The communication medium 804 may be implemented in various ways. For example, the communication medium 804 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 8, the instructions stored in the memory 802 may include those that, when executed by the processor 801, cause the UE 800 to implement the method described with respect to FIG. 4.

FIG. 9 is another block diagram illustrating a UE 900 in an IMS network according to some embodiments of the present disclosure. As an example, the UE 900 may act as a combination of the UE 201 as shown in FIG. 2 and the UE 301 as shown in FIG. 3, but it is not limited thereto. It should be appreciated that the UE 900 may be implemented using components other than those illustrated in FIG. 9.

With reference to FIG. 9, the UE 900 may comprise at least a transmission unit 901 and a receiving unit 902. The transmission unit 901 may be adapted to perform at least the operation described in the block 401 of FIG. 4. The receiving unit 902 may be adapted to perform at least the operation described in the block 402 of FIG. 4.

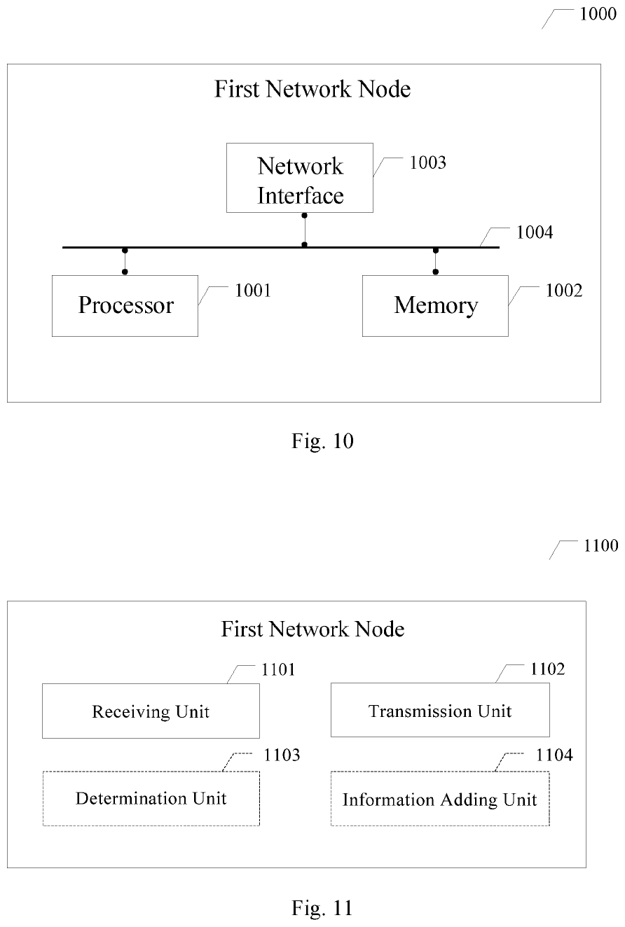

FIG. 10 is a block diagram illustrating a first network node 1000 in an IMS communication network according to some embodiments of the present disclosure. As an example, the first network node 1000 may act as a combination of the P-CSCF 202 as shown in FIG. 2 and the P-CSCF 302 as shown in FIG. 3, but it is not limited thereto. It should be appreciated that the first network node 1000 may be implemented using components other than those illustrated in FIG. 10.

With reference to FIG. 10, the first network node 1000 may comprise at least a processor 1001, a memory 1002, a network interface 1003 and a communication medium 1004. The processor 1001, the memory 1002 and the network interface 1003 may be communicatively coupled to each other via the communication medium 1004.

The processor 1001, the memory 1002, the network interface 1003 and the communication medium 1004 are structurally similar to the processor 801, the memory 802, the network interface 803 and the communication medium 804 respectively, and will not be described herein in detail.

In the example of FIG. 10, the instructions stored in the memory 1002 may include those that, when executed by the processor 1001, cause the first network node 1000 to implement the method described with respect to FIG. 5.

FIG. 11 is another block diagram illustrating a first network node 1100 in an IMS communication network according to some embodiments of the present disclosure. As an example, the first network node 1100 may act as a combination of the P-CSCF 202 as shown in FIG. 2 and the P-CSCF 302 as shown in FIG. 3, but it is not limited thereto. It should be appreciated that the first network node 1100 may be implemented using components other than those illustrated in FIG. 11.

With reference to FIG. 11, the first network node 1100 may comprise at least a receiving unit 1101 and a transmission unit 1102. The receiving unit 1101 may be adapted to perform at least the operation described in the block 501 of FIG. 5. The transmission unit 1102 may be adapted to perform at least the operation described in the block 505 of FIG. 5.

In an example, the first network node 1100 may further comprise a determination unit 1103 and an information adding unit 1104. The determination unit 1103 may be adapted to perform at least the operation described in the block 502 of FIG. 5. The information adding unit 1104 may be adapted to perform at least the operations described in the blocks 503 and 504 of FIG. 5.

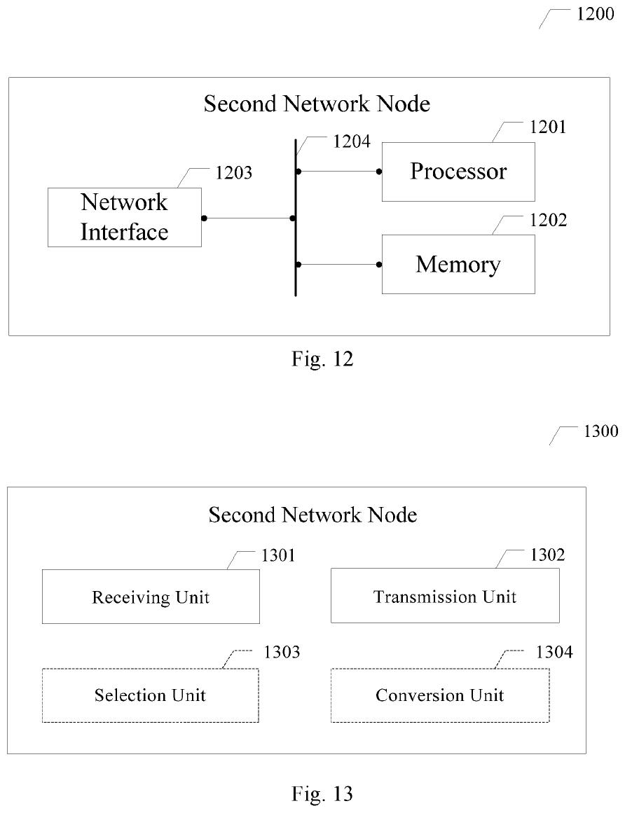

FIG. 12 is a block diagram illustrating a second network node 1200 in an IMS communication network according to some embodiments of the present disclosure. As an example, the second network node 1200 may act as a combination of the S-CSCF 204 as shown in FIG. 2 and the S-CSCF 304 as shown in FIG. 3, but it is not limited thereto. It should be appreciated that the second network node 1200 may be implemented using components other than those illustrated in FIG. 12.

With reference to FIG. 12, the second network node 1200 may comprise at least a processor 1201, a memory 1202, a network interface 1203 and a communication medium 1204. The processor 1201, the memory 1202 and the network interface 1203 are communicatively coupled to each other via the communication medium 1204.

The processor 1201, the memory 1202, the network interface 1203 and the communication medium 1204 are structurally similar to the processor 801 or 1001, the memory 802 or 1002, the network interface 803 or 1003 and the communication medium 804 or 1004 respectively, and will not be described herein in detail.

In the example of FIG. 12, the instructions stored in the memory 1202 may include those that, when executed by the processor 1201, cause the second network node 1200 to implement the method described with respect to FIG. 6.

FIG. 13 is another block diagram illustrating a second network node 1300 in an IMS communication network according to some embodiments of the present disclosure. As an example, the second network node 1300 may act as a combination of the S-CSCF 204 as shown in FIG. 2 and the S-CSCF 304 as shown in FIG. 3, but it is not limited thereto. It should be appreciated that the second network node 1300 may be implemented using components other than those illustrated in FIG. 13.

With reference to FIG. 13, the second network node 1300 may comprise at least a receiving unit 1301 and a transmission unit 1302. The receiving unit 1301 may be adapted to perform at least the operation described in the block 601 of FIG. 6. The transmission unit 1302 may be adapted to perform at least the operation described in the block 604 of FIG. 6.

In an example, the second network node 1300 may further comprise a selection unit 1303 and a conversion unit 1304. The selection unit 1303 may be adapted to perform at least the operation described in the block 602 of FIG. 6. The conversion unit 1304 may be adapted to perform at least the operation described in the block 603 of FIG. 6.

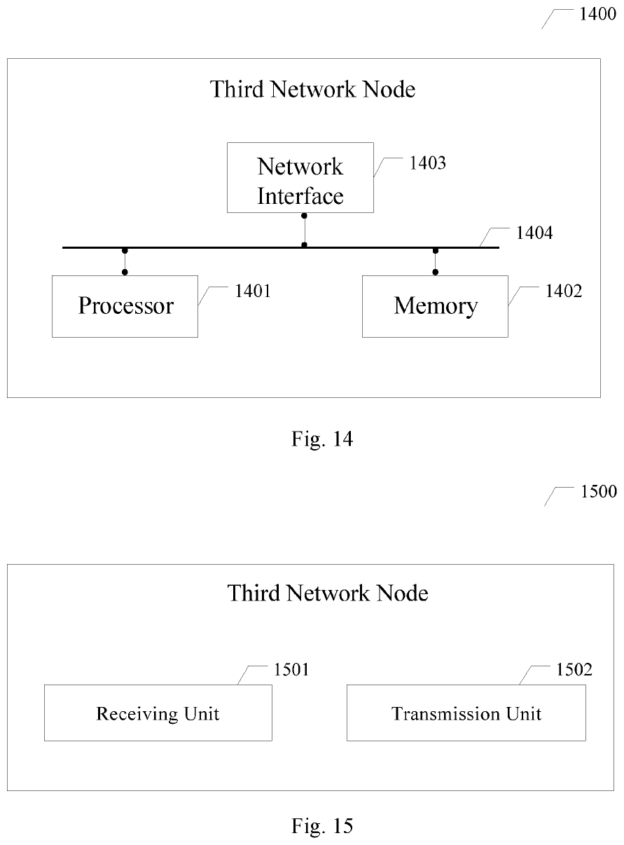

FIG. 14 is a block diagram illustrating a third network node 1400 in an IMS communication network according to some embodiments of the present disclosure. As an example, the third network node 1400 may act as the P-CSCF 303 as shown in FIG. 3, but it is not limited thereto. It should be appreciated that the third network node 1400 may be implemented using components other than those illustrated in FIG. 14.

With reference to FIG. 14, the third network node 1400 may comprise at least a processor 1401, a memory 1402, a network interface 1403 and a communication medium 1404. The processor 1401, the memory 1402 and the network interface 1403 are communicatively coupled to each other via the communication medium 1404.

The processor 1401, the memory 1402, the network interface 1403 and the communication medium 1404 are structurally similar to the processor 801, 1001 or 1201, the memory 802, 1002 or 1202, the network interface 803, 1003 or 1203 and the communication medium 804, 1004 or 1204 respectively, and will not be described herein in detail.

In the example of FIG. 14, the instructions stored in the memory 1402 may include those that, when executed by the processor 1401, cause the third network node 1400 to implement the method described with respect to FIG. 7.

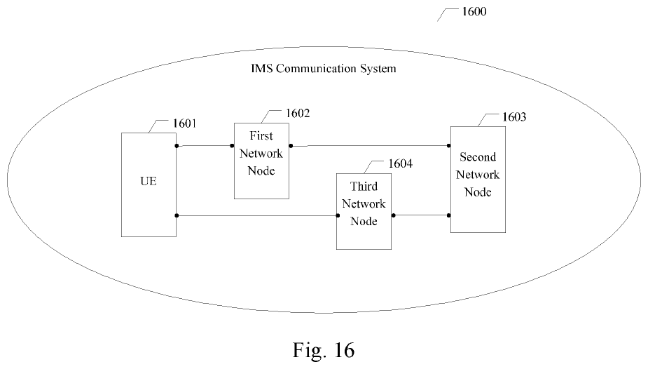

FIG. 15 is another block diagram illustrating a third network node 1500 in an IMS communication network according to some embodiments of the present disclosure. As an example, the third network node 1500 may act as the P-CSCF 303 as shown in FIG. 3, but it is not limited thereto. It should be appreciated that the third network node 1500 may be implemented using components other than those illustrated in FIG. 15.

With reference to FIG. 15, the third network node 1500 may comprise at least a receiving unit 1501 and a transmission unit 1502. The receiving unit 1501 may be adapted to perform at least the operation described in the block 701 of FIG. 7. The transmission unit 1502 may be adapted to perform at least the operation described in the block 702 of FIG. 7.

The units 901-904, 1101-1104, 1301-1304 and 1501-1504 are illustrated as separate units in FIGS. 9, 11, 13 and 15. However, this is merely to indicate that the functionality is separated. The units may be provided as separate elements. However, other arrangements are possible, e.g., some of them may be combined as one unit in each figure. Any combination of the units may be implemented in any combination of software, hardware, and/or firmware in any suitable location. For example, there may be more controllers configured separately, or just one controller for all of the components.

The units shown in FIGS. 9, 11, 13 and 15 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 4-7.

FIG. 16 is a block diagram illustrating an IMS communication system 1600 according to some embodiments of the present disclosure. The IMS communication system 1600 comprises at least a UE 1601, a first network node 1602, a second network node 1603 and a third network node 1604. In one embodiment, the UE 1601 and the first to third network nodes 1602-1604 may act as the UE 800 as depicted in FIG. 8, the first network node 1000 as depicted in FIG. 10, the second network node 1200 as depicted in FIG. 12 and the third network node 1400 as depicted in FIG. 14 respectively. In one embodiment, the first network node 1602 may communicate with at least the UE 1601 and the second network node 1603, and the third network node 1604 may communicate with at least the second network node 1603 and the UE 1601.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a user equipment in an Internet protocol Multimedia Subsystem communication network, the method comprising:
transmitting, to a first network node, a register request comprising a list of network nodes for the user equipment; and
receiving a terminating request from the first network node or a third network node included in the list.

2. The method of claim 1, wherein the register request further comprises routing information of the user equipment in a contact header or a path header of the register request.

3. The method of claim 1, wherein the first network node and other network nodes included in the list are Proxy Call Session Control Function nodes.

4. A method implemented by a first network node in an Internet protocol Multimedia Subsystem communication network, the method comprising:
receiving a register request from a user equipment; and
transmitting the register request which comprises at least contact information of the user equipment to a second network node.

5. The method of claim 4, further comprising:
determining whether the register request received from the user equipment comprises the contact information of the user equipment; and
adding the contact information to the register request in response to determining that the contact information is not comprised in the received register request.

6. The method of claim 5, wherein the step of adding further comprises:
in response to determining that a contact header of the register request comprises a domain name of the user equipment, replacing the domain name with a parameter indicating an internet protocol address, a port number and a transport type for the user equipment.

7. The method of claim 4, further comprising:
receiving periodical heart-beat requests from the second network node; and
transmitting responses to the heart-beat requests to the second network node.

8. The method of claim 4, wherein the register request comprises a list of network nodes for the user equipment.

9. The method of claim 4, wherein the contact information includes at least an internet protocol address, a port number and a transport type.

10. The method of claim 4, wherein the first network node is a Proxy Call Session Control Function node and wherein the second network node is a Serving Call Session Control Function node.

11-33. (canceled)

34. A user equipment in an Internet protocol Multimedia Subsystem communication network, comprising:
a processor; and
a memory communicatively coupled to the processor and adapted to store instructions which, when executed by the processor, cause the user equipment to:
transmit, to a first network node, a register request comprising a list of network nodes for the user equipment; and
receive a terminating request from the first network node or a third network node included in the list.

35. The user equipment of claim 34, wherein the register request further comprises routing information of the user equipment in a contact header or a path header of the register request.

36. The user equipment of claim 34, wherein the first network node and other network nodes included in the list are Proxy Call Session Control Function nodes.

37. A first network node in an Internet protocol Multimedia Subsystem communication network, comprising:
a processor; and
a memory communicatively coupled to the processor and adapted to store instructions which, when executed by the processor, cause the first network node to:
receive a register request from a user equipment; and
transmit the register request which comprises at least contact information of the user equipment to a second network node.

38. The first network node of claim 37, wherein the instructions, when executed by the processor, cause the first network node to:
determine whether the register request received from the user equipment comprises the contact information of the user equipment; and
add the contact information to the register request in response to determining that the contact information is not comprised in the received register request.

39. The first network node of claim 38, wherein to add the contact information comprises:
in response to determining that a contact header of the register request comprises a domain name of the user equipment, replacing the domain name with a parameter indicating an internet protocol address, a port number and a transport type for the user equipment.

40. The first network node of claim 37, wherein the instructions, when executed by the processor, cause the first network node to:
receive periodical heart-beat requests from the second network node; and
transmit responses to the heart-beat requests to the second network node.

41. The first network node of claim 37, wherein the register request comprises a list of network nodes for the user equipment.

42. The first network node of claim 37, wherein the contact information includes at least an internet protocol address, a port number and a transport type.

43. The first network node of claim 37, wherein the first network node is a Proxy Call Session Control Function node and wherein the second network node is a Serving Call Session Control Function node.
